(19) United States
(12) Patent Application Publication
(10) Pub. No.: US 2011/0268388 A1
(43) Pub. Date: Nov. 3, 2011

(54) OPTICAL CONNECTION SYSTEM

(76) Inventor: Benny Gaber, Haifa (IL)

(21) Appl. No.: 13/143,934

(22) PCT Filed: Jan. 13, 2010
(86) PCT No.: PCT/US10/20827

§ 371 Date: Jul. 11, 2011

Related U.S. Application Data
(60) Provisional application No. 61/144,160, filed on Jan. 13, 2009.

(51) Int. Cl. G02B 6/32

(52) U.S. Cl. 385/33

(57) ABSTRACT

An optical connection system (1) between two fiber optic lines including an in-line collimator (5) and an out-line collimator (9) rotatably mounted on a base (2), wherein the collimators (5, 9) rotate on the same rotatable plane (13) and lines of sight of the collimators (5, 9) rotate in a plane parallel to the rotatable plane (13), and light detectors (15) located at the collimators (5, 9), wherein the collimators (5, 9) are rotatable until a light signal transmitted from one of the collimators (5, 9) reaches a desired received level by the light detector (15) at the other collimator (9, 5), thereby co-aligning lines of sight of the collimators (5, 9).

### FIELD OF THE INVENTION

The present invention relates generally to an optical connection, such as a patch panel terminal for fiber optics, comprising a pigtail collimator interconnection between any member of an inline array of incoming fiber optics to any member of an output array of fiber optic lines.

### BACKGROUND OF THE INVENTION

Fiber optics distribution frames, patch panels and termination devices today are the last manually-installed, layer-one connectivity products installed in a fiber optic network. Some arrangements using pigtail collimators are available today; however, they need a two-dimension, linear directional head, such as up or down and left or right, to co-align their line of sight.

### SUMMARY OF THE INVENTION

In accordance with an embodiment of the present invention, an optical connection is provided between two fiber optic lines, each ending with a pigtail collimator, whose lines of sight are co-aligned by rotating the collimators on rotatable supports (e.g., motors), as is described more in detail below.

There is thus provided in accordance with an embodiment of the present invention an optical connection system between two fiber optic lines including an in-line collimator and an out-line collimator rotatably mounted on a base, wherein the collimators rotate on the same rotatable plane and lines of sight of the collimators rotate in a plane parallel to the rotatable plane, and light detectors located at the collimators, wherein the collimators are rotatable until a light signal transmitted from one of the collimators reaches a desired received level by the light detector at the other collimator, thereby co-aligning lines of sight of the collimators.

In accordance with an embodiment of the present invention the collimators are mounted on rotatable motors which are mounted on the base. A plurality of pairs of in-line collimators and out-line collimators may be rotatably mounted on the base.

In accordance with an embodiment of the present invention the in-line collimator is located at a center of a circle, and a plurality of out-line collimators are mounted radially around collimator facing collimator.

In accordance with an embodiment of the present invention the collimators include pigtail collimators.

In accordance with an embodiment of the present invention a control fiber splitter provides the light signal.

There is also provided in accordance with an embodiment of the present invention a method for co-aligning lines of sight of collimators in an optical connection system between two fiber optic lines, the method including rotatably mounting an in-line collimator and an out-line collimator on a base, wherein the collimators rotate on the same rotatable plane and lines of sight of the collimators rotate in a plane parallel to the rotatable plane, providing light detectors located at the collimators, and rotating the collimators in iterations until a light signal transmitted from one of the collimators reaches a desired received level by the light detector at the other collimator, thereby co-aligning lines of sight of the collimators.

### BRIEF DESCRIPTION OF THE DRAWINGS

The disclosed technique will be understood and appreciated more fully from the following detailed description taken in conjunction with the drawings in which:

FIGS. 1A and 1B are schematic general view and front view illustrations, respectively, of an optical connection system between two fiber optic lines, one line of an in-line array to one line of an out-line array, in accordance with an embodiment of the present invention.

FIGS. 2A and 2B are schematic general view and front view illustrations, respectively, of the system containing a fully aligned, optical connection between one line of the in-line array to one line of the out-line array, in accordance with an embodiment of the present invention.

FIG. 3 is a schematic general side view of the plane about which the optical lines of sight of the receiving and sending collimators are rotatable, in accordance with an embodiment of the present invention.

FIG. 4 is a schematic general view illustration of a pigtail collimator, and a parallel light beam emerging from it, attached to a rotatable motor, in accordance with an embodiment of the present invention.

FIGS. 5A, 5B and 5C are schematic general view, front view and side view illustrations, respectively, of the system including three optical connections between lines of the in-line array and lines of the out-line array, in accordance with an embodiment of the present invention.

FIGS. 6A and 6B are schematic general view and front view illustrations, respectively, of a single fiber optic inline with a pigtail collimator mounted on a motor (e.g., a piezomotor) and an array of outlines mounted on a circle along with a light beam emitted from the collimator, in accordance with an embodiment of the present invention.

FIG. 7 is a schematic general view illustration of a bifocal collimator with two fiber optics attached to it, in accordance with an embodiment of the present invention.

FIGS. 8A and 8B are schematic side view and sectional view illustrations, respectively, of the bifocal collimator with two fiber optics attached to it.

FIGS. 9A and 9B are schematic general view and front view illustrations, respectively, of a bifocal lens, in accordance with an embodiment of the present invention.

### DETAILED DESCRIPTION OF THE EMBODIMENT

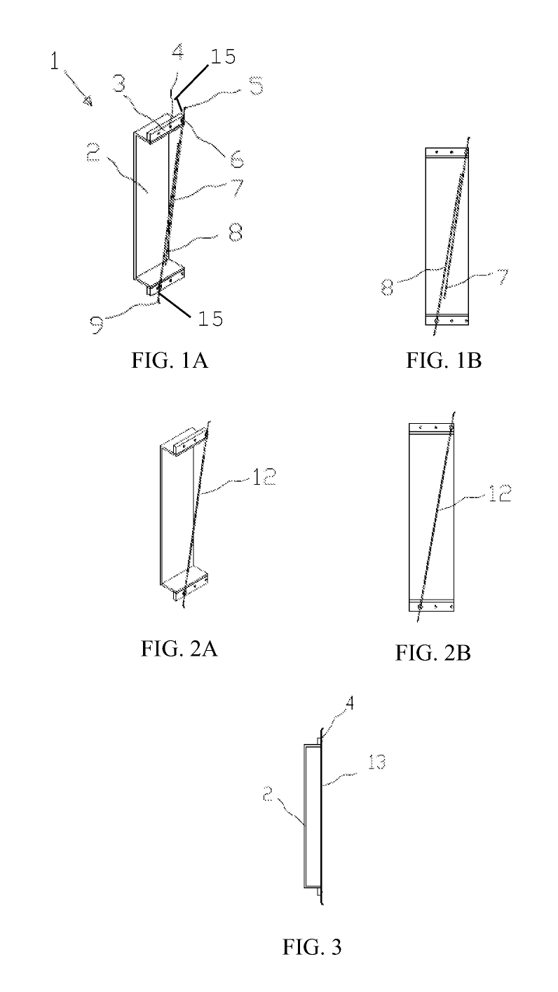

Reference is now made to FIGS. 1A and 1B, which illustrate an optical connection system 1 between two fiber optic lines, in accordance with a non-limiting embodiment of the present invention.

System 1 includes a common base 2, on which are mounted an in-line (receiving) pigtail collimator 5 and an out-line (sending) pigtail collimator 9. The collimators 5 and 9 are mounted on rotatable motors 6 (e.g., piezomotors, step motors or other suitable rotatable devices) on support plates 3 that protrude from base 2. Both collimators 5 and 9 rotate on the same rotatable plane. The lines of sight of the collimators rotate in a plane parallel to the rotatable plane. Motors 6 are mounted at locations 4. Light beams 7 and 8 exit collimators 5 and 9, respectively. Initially, light beam 7 is not fully co-aligned with light beam 8. FIG. 1B clearly shows the misalignment of beams 7 and 8. The collimators 5 and 9 are provided with light detectors 15.

In accordance with an embodiment of the present invention, collimators 5 and 9 are rotated in rotational iterations until a light signal transmitted from one collimator reaches the desired received level by the light detector at the other collimator, thereby co-aligning their mutual lines of sight.

Co-alignment of the mutual lines of sight of the collimators is achieved by an open loop iteration procedure where a generally directional rotation is given to both collimators, one from inline and the other from the outline, so that the collimators are roughly facing each other. A light signal from one of the collimators is then measured by a light detector on the receiving collimator. A small rotation movement is then applied to one of the collimators rotational support in two rotational directions (e.g., clockwise and counterclockwise) and the best light signal detected is compared to the previous position, until an optimal position is achieved.

This is the first iteration. The same procedure is performed by rotating the other collimator in the two directions reaching a better light signal passing between them. This is the second iteration. The iterations may be repeated until the light signal passing through is sufficient. The procedure is then repeated for any other pair of lines.

FIGS. 2A and 2B show the alignment completed to a common line of sight 12. FIG. 3 is a side view of the alignment in FIGS. 2A and 2B, showing a rotatable plane 13 in which the collimators rotate.

The above system can be applied in any two parallel fiber optic pigtail collimators facing each other, such as two parallel lines of the same number of collimators or two parallel curved lines of the same number of collimators, or any combination thereof, with different numbers of collimators on the in-lines and the outlines.

As all the light beams pass in the same plane, some beams between neighboring lines will cross each other; however, according to the laws of physics no degradation of the signal passing between any two opposed collimators will occur.

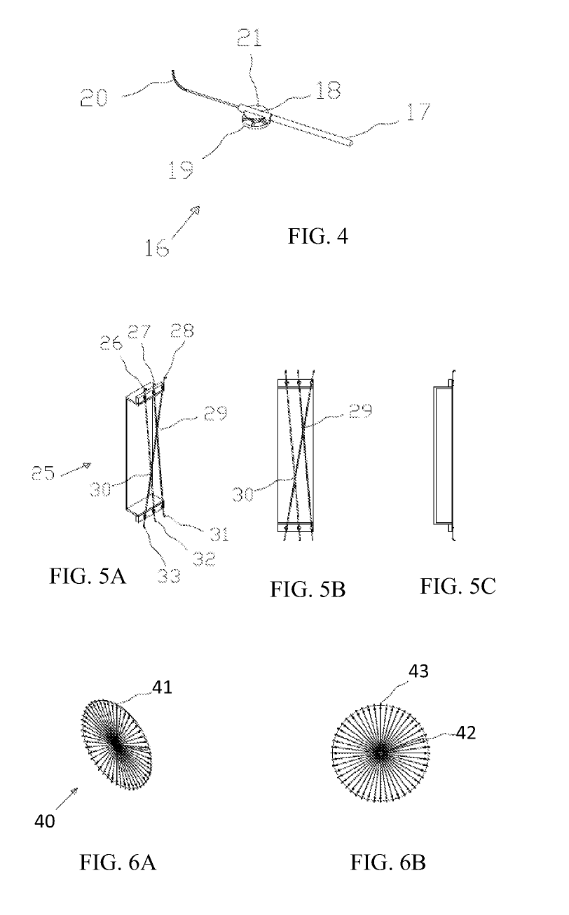

Reference is now made to FIG. 4, which illustrates another example of an arrangement for holding and rotating the collimator. In this embodiment, a pigtail collimator assembly 16 includes a collimator 18, a fiber optic line 20, a piezomotor stator and rotor 19, and a holder 21 that holds collimator 18. A parallel light beam 17 exits collimator 18.

Reference is now made to FIGS. 5A, 5B and 5C, which illustrate a switching device 25 with three in-line fiber optic lines with pigtail collimators 26, 27 and 28, and opposing them on the same plane, three out-line fiber optic lines with pigtail collimators 31, 32 and 33. Line 26 is optically connected to line 32, line 27 is connected to line 32 and line 28 is connected to line 33. The lines connected via the light beams to and from the collimators cross each other at points 29 and 30. FIG. 5B is a front view of FIG. 5A, showing the crossing points 29 and 30 in the rotational plane of the light beams.

Another embodiment includes an in-line fiber optic pigtail collimator located at a center of a circle, and out-lines of out-line collimators are mounted on the circle facing the pigtail collimator. Such an embodiment is shown schematically in FIGS. 6A and 6B, which illustrate a circular switching device 40 mounted on a circular array 41. An in-line fiber optic pigtail collimator 42 is located at the center of the circle, and out-lines 43 are mounted radially around collimator 42 facing collimator 42.

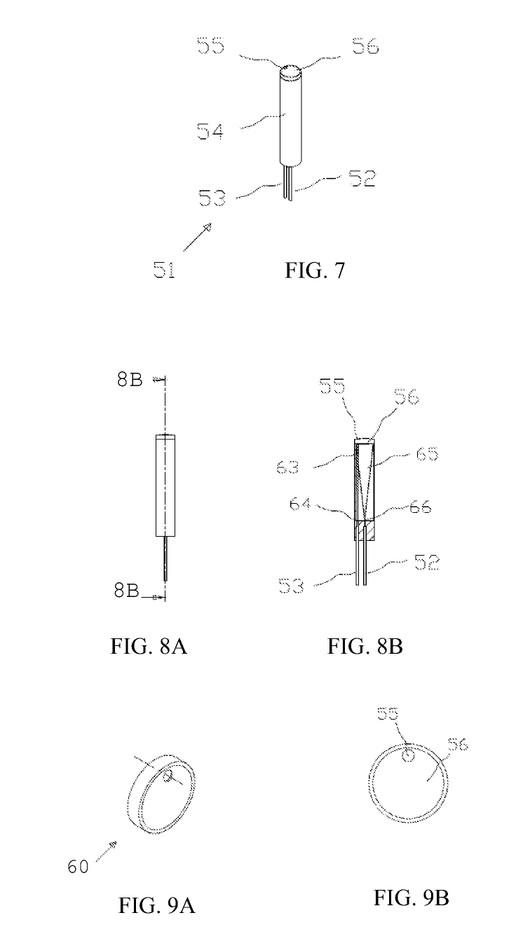

Reference is now made to FIG. 7. In accordance with another embodiment of the present invention, a non-inclusive control fiber splitter 53 serves as a send-receive light signal used in the aligning procedure above to co-align the line of sight of a bifocal pigtail fiber optic collimator 51. The main collimator lens 56 includes or is modified into a bi-focal lens 55. A main fiber optic line 52 enters the center of the collimator body 54. The non-inclusive control fiber splitter 53 is mounted eccentrically with respect to the collimator body 54.

Reference is now made to FIGS. 8A and 8B, which illustrate the main lens 56 with its focal cone 65 that concentrates incoming parallel light to the focal point 66 which is the end point of the main fiber optic line 52, and secondary lens 55 with its focal cone 63 that concentrates incoming parallel light to the focal point 64 which is the end point of the non-inclusive control splitter 53 fiber optic line.

FIG. 9A is a general view of bifocal lens 60. FIG. 9B illustrates bifocal lens 60 with the main lens 56 and the bifocal lens 55.

1-8. (canceled)

9. An optical connection system between two fiber optic lines comprising:
an in-line collimator and an out-line collimator rotatably mounted on a base, said collimators being mounted on rotatable motors which are mounted on said base, wherein said collimators rotate on the same rotatable plane and lines of sight of said collimators rotate in a plane parallel to the rotatable plane; and
light detectors associated with said collimators, wherein said collimators are rotatable until a light signal transmitted from one of said collimators reaches a desired received level by the light detector at the other collimator, thereby co-aligning lines of sight of said collimators;
wherein at least one of said collimators comprises a bi-focal lens and a main fiber optic line is located at a center of said collimator that comprises said bi-focal lens, and wherein said lens concentrates incoming parallel light to a focal point which is an end point of said main fiber optic line.

10. The optical connection system according to claim 9, further comprising a control fiber splitter mounted eccentrically with respect to said collimator and a secondary lens that concentrates incoming parallel light to another focal point which is an end point of said control fiber splitter.

11. The optical connection system according to claim 9, wherein said motors comprise piezomotors.

12. The optical connection system according to claim 9, comprising a plurality of pairs of in-line collimators and out-line collimators rotatably mounted on said base.

13. The optical connection system according to claim 9, wherein said in-line collimator is located at a center of a circle, and a plurality of out-line collimators are mounted radially around collimator facing collimator.

14. The optical connection system according to claim 9, wherein said collimators comprise pigtail collimators.
